(19) United States
(12) Patent Application Publication
(10) Pub. No.: US 2023/0291456 A1
(43) Pub. Date: Sep. 14, 2023

(54) BEAM SET FOR CHANNEL STATE INFORMATION FEEDBACK IN MIMO SYSTEMS

(71) Applicant: HUAWEI TECHNOLOGIES CO., LTD., SHENZHEN (CN)

(72) Inventor: HAMIDREZA FARMANBAR, Kanata (CA)

(21) Appl. No.: 18/317,444

(22) Filed: May 15, 2023

Related U.S. Application Data
(63) Continuation of application No. PCT/CN2020/130431, filed on Nov. 20, 2020.

(51) Int. Cl. H04B 7/06; H04W 24/10

(52) U.S. Cl. CPC H04B 7/0626; H04B 7/0634; H04W 24/10

(57) ABSTRACT

Systems and methods are provided that involve the design and use of beam sets for CSI feedback that are customized for to a given environment, for example, a room, a hallway, an outdoor area, an indoor area. This can have the effect of reducing the number of beams within the beam set that are used to represent the downlink channel of a UE in a given environment, with a corresponding reduction in the overhead to feedback CSI. A customized beam set, once determined, is configured on a given UE using signalling. A UE that makes channel measurements on a received reference signal uses the channel measurements to obtain a set of beamforming weights for the customized beam set and sends the weights back to the network as CSI.

### CROSS-REFERENCE TO RELATED APPLICATION

This application is a continuation of International Application No. PCT/CN2020/130431, filed on Nov. 20, 2020, the disclosure of which is hereby incorporated by reference in its entirety.

### FIELD

The application relates to downlink channel state feedback in multiple input multiple output (MIMO) systems.

### BACKGROUND

Downlink channel state information (CSI) is required at a base station (BS) in order to achieve predicted data rate gains of massive MIMO. In Long Term Evolution (LTE) and 5G, CSI is made available at the BS through a process that includes CSI acquisition and feedback. With this process, the BS sends CSI reference symbols (CSI-RS) to a user equipment (UE). The UE measures the channel given the received CSI-RS and sends back CSI to the BS.

In 5G New Radio (NR), the precoding matrix used for feedback by the UE to the base station, e.g. a gNB, can be written as

$$W = {W}_{1} {W}_{2}$$

where columns of W₁ comprise 2D-DFT beams. In type 2 CSI feedback, W₂ contains wideband and subband amplitudes and phase combining information corresponding to each beam. So the feedback overhead includes sending the 2D-DFT beam indices, as well as the corresponding wideband and subband amplitudes and phase combining information.

There is a desire for a method of determining channel state information with reduced signaling overhead.

### SUMMARY

Systems and methods are provided that involve the design and use of beam sets for CSI feedback that are customized for to a given environment, for example, a room, a hallway, an outdoor area, an indoor area. This can have the effect of reducing the number of beams within the beam set that are used to represent the downlink channel of a UE in a given environment, with a corresponding reduction in the overhead to feedback CSI. A beam set, once determined, is configured to be used by given UE using signalling. A UE that makes channel measurements on a received reference signal uses the channel measurements to obtain a set of beams within the beam set and sends the indices of the beams along with the corresponding weights back to the network as CSI.

According to one aspect of the present disclosure, there is provided a method in an apparatus, the method comprising: receiving, by the apparatus from a network device, a respective configuration of each beam of a beam set for reporting downlink channel state information (CSI) feedback, each beam having a beam index; the apparatus receiving a reference signal transmitted with a plurality of antennas or antenna ports and obtaining channel measurements; and the apparatus transmitting a set of beamforming weights and corresponding beam indices obtained from the channel measurements using the beam set.

Advantageously, this approach has the advantages of lower CSI feedback overhead given the same channel acquisition performance, better channel acquisition performance given the same CSI feedback overhead, and lower UE power consumption for selecting appropriate beams in the beam set.

Optionally, in any of the previous embodiments, receiving the reference signal transmitted with a plurality of antennas or antenna ports comprises receiving the reference signal transmitted with N antennas or antenna ports, where N≥2; receiving the reference signal is performed with a plurality R of antennas or antenna ports, where R≥1; and obtaining channel measurements comprises obtaining a set of N channel measurements for each of the R antennas or antenna ports.

Optionally, in any of the previous embodiments, the method further comprises: determining L precoding vectors of size N from the R sets of N channel measurements where L≤min(R,N) is a number of spatial layers; wherein transmitting the set of beamforming weights and corresponding beam indices obtained from the channel measurements using the beam set comprises: for each of the L layers, transmitting a respective layer specific set of beam indices and the corresponding layer specific beamforming weights obtained from the precoding vector for that layer using the beam set.

Advantageously, this approach extends the advantages of the previously described approach to multi-layer applications. In addition, the base station can use the weights to recover the precoding vectors, and can use those to directly encode data for transmission.

Optionally, in any of the previous embodiments, receiving by the apparatus the configuration of the beam set comprises receiving radio resource control (RRC) signaling.

Advantageously, this provides a convenient and efficient way to configure an apparatus with the beam set.

Optionally, in any of the previous embodiments, the method further comprises obtaining the beamforming weights and indices from the channel measurements using the beam set by determining beamforming weights by: calculating a singular value decomposition SVD of a measured channel matrix H = UΛV*; determining L precoding vectors by using L singular vectors of V as the L precoding vectors, where L is a number of spatial layers; and for each of the L precoding vectors, determining beamforming weights that represent the L precoding vector as a weighted linear combination of beams in the beam set.

Optionally, in any of the previous embodiments, the method further comprises obtaining the beamforming weights and indices from the channel measurements using the beam set by determining indices of beams within the beam set and corresponding weights of beams in the beam set for representing the channel vector as a weighted linear combination of the beams within the beam set.

Advantageously, this provides a specific method of for conveying the channel measurements per se back to the base station.

According to another aspect of the present disclosure, there is provided a method in a network device, the method comprising: transmitting by the network device to an apparatus a respective configuration of each beam of a beam set for reporting downlink channel state information (CSI) feedback, each beam having a beam index; the network device transmitting a reference signal with a plurality of antennas or antenna ports; and the network device receiving a set of beamforming weights and corresponding beam indices obtained from channel measurements using the beam set.

Advantageously, this approach has the advantages of lower CSI feedback overhead given the same channel acquisition performance, better channel acquisition performance given the same CSI feedback overhead, and lower UE power consumption for selecting appropriate beams in the beam set.

Optionally, in any of the previous embodiments, the method further comprises using the beamforming weights and beam indices and the beam set to reconstruct the channel measurements.

Optionally, in any of the previous embodiments, the method further comprises using the beamforming weights and beam indices and the beam set to reconstruct a respective precoding vector for each of L layers.

Advantageously, the reconstructed channel measurements can then be used in the conventional way. Alternatively, the network can make use of the beamforming weights directly.

Optionally, in any of the previous embodiments, using the beamforming weights and beam indices and the beam set to reconstruct the channel measurements comprises determining a sum of the beamforming weights multiplied by beams of the beam set.

Optionally, in any of the previous embodiments, transmitting the configuration of the beam set comprises transmitting radio resource control (RRC) signaling.

Advantageously, this provides a simple and efficient way to configure the beam set on an apparatus.

Optionally, in any of the previous embodiments, the method further comprises determining the beam set by training an autoencoder architecture using channel samples.

Optionally, in any of the previous embodiments, the channel samples are downlink channel samples, or uplink channel samples, or samples generated according to a transmitter antenna array steering vector at angles of departure within an angle of departure range.

Advantageously, using downlink channel samples has the advantage of the most accuracy; using uplink channel samples has the advantage of convenience in that uplink channel samples are available directly at the base station without additional signaling. The use of the transmitter antenna array steering vector approach has the advantage that no actual channel samples need be collected.

Optionally, in any of the previous embodiments, the beam set comprises rows of a matrix V* corresponding to some or all non-zero singular values in Λ, where H = UΛV* is a singular value decomposition of an aggregate matrix containing stacked channel vector samples.

Optionally, in any of the previous embodiments, the channel vector samples are downlink channel samples, or uplink channel samples, or samples generated according to a transmitter antenna array steering vector at angles of departure within an angle of departure range.

Optionally, in any of the previous embodiments, receiving a set of beamforming weights and indices obtained from the channel measurements using the beam set comprises, for each of L layers, receiving a respective set of beamforming weights and indices obtained from a set of channel measurements for that layer using the beam set.

Advantageously, this approach extends the advantages of the previously described approach to multi-layer applications.

According to another aspect of the present disclosure, there is provided an apparatus comprising; a processor and a memory; wherein the apparatus configured to perform a method comprising: receiving, by the apparatus from a network device, a respective configuration of each beam of a beam set for reporting downlink channel state information (CSI) feedback, each beam having a beam index; the apparatus receiving a reference signal transmitted with a plurality of antennas or antenna ports and obtaining channel measurements; and the apparatus transmitting a set of beamforming weights and corresponding beam indices obtained from the channel measurements using the beam set.

Optionally, in any of the previous embodiments, the apparatus is further configured to obtain the beamforming weights and indices from the channel measurements using the beam set by determining indices of beams within the beam set and corresponding weights of beams in the beam set for representing the channel vector as a weighted linear combination of the beams within the beam set.

According to another aspect of the present disclosure, there is provided network device comprising: a processor and a memory; wherein the network device is configured to execute a method comprising: transmitting by the network device to an apparatus a respective configuration of each beam of a beam set for reporting downlink channel state information (CSI) feedback, each beam having a beam index; the network device transmitting a reference signal with a plurality of antennas or antenna ports; and the network device receiving a set of beamforming weights and corresponding beam indices obtained from channel measurements using the beam set.

Optionally, in any of the previous embodiments, the network device is further configured to determine the beam set by training an autoencoder architecture using channel samples.

### BRIEF DESCRIPTION OF THE DRAWINGS

Embodiments of the disclosure will now be described with reference to the attached drawings in which:

FIG. 1 shows an example of a network for implementing one or more embodiments of the disclosure;

FIG. 2A is a block diagram of an example electronic device; and

FIG. 2B is a block diagram of an example base station.

FIG. 3A is a block diagram of another example electronic device; and

FIG. 3B is a block diagram of another example base station.

FIG. 4 is a flowchart of a method for execution by a UE;

FIG. 5 is a flowchart of a method for execution by a base station;

FIG. 6 is a block diagram of an autoencoder architecture for determining a beam set;

FIG. 7 shows an example of the accuracy of using a beam set as a function of the size of the beam set.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

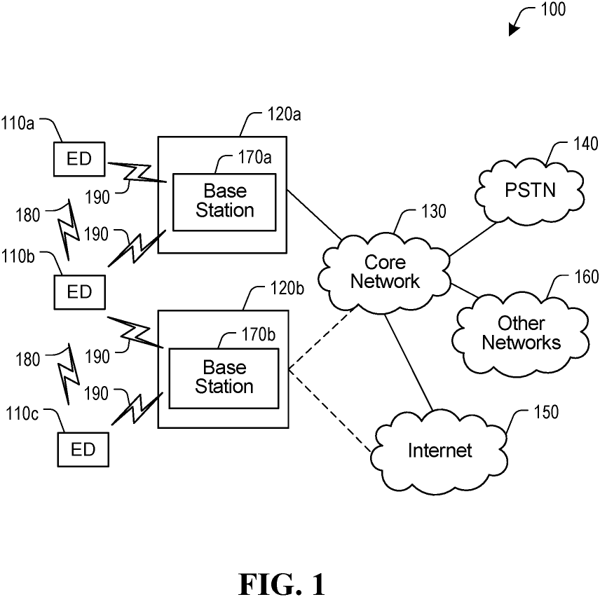

FIG. 1 illustrates an example communication system 100 in which embodiments of the present disclosure may be implemented. In general, the communication system 100 enables multiple wireless or wired elements to communicate data and other content. The purpose of the communication system 100 may be to provide content (voice, data, video, text) via broadcast, narrowcast, user device to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1, any reasonable number of these components or elements may be included in the communication system 100.

The EDs 110a-110c are configured to operate, communicate, or both, in the communication system 100. For example, the EDs 110a-110c are configured to transmit, receive, or both via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission point (TP), a site controller, an access point (AP), or a wireless router. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150, as shown. The detailed embodiments described herein make reference to TPs, but more generally, any type of base station can be used for any of the embodiments described herein.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc.. The air interfaces 190 may utilize any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+ optionally including HSDPA, HSUPA or both. Alternatively, a base station 170a-170b may establish an air interface 190 with Evolved UTMS Terrestrial Radio Access (E-UTRA) using LTE, LTE-A, LTE-B and/or New Radio (NR). It is contemplated that the communication system 100 may use multiple channel access functionality, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

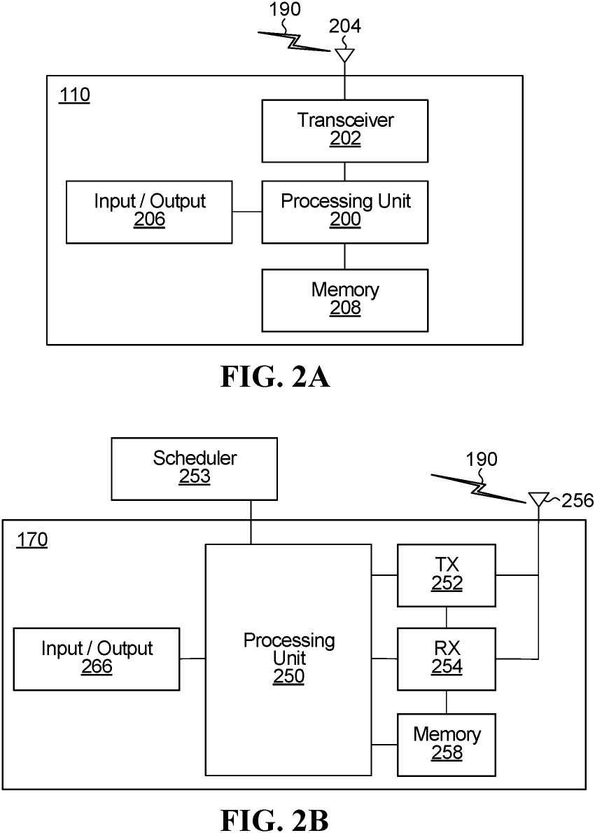

FIG. 2A and FIG. 2B illustrate example devices that may implement the methods and teachings according to this disclosure. In particular, FIG. 2A illustrates an example ED 110, and FIG. 2B illustrates an example base station 170. These components could be used in the communication system 100 or in any other suitable system. As shown in FIG. 2A, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail above. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. More generally, there may be R antenna elements or antenna ports, where R>=1. Each antenna element 204 may be associated with an antenna port. An antenna port is a logical construct, and may have one or more than one associated antenna element 204. In an embodiment, an antenna port is defined such that the channel over which a symbol on the antenna port is conveyed can be inferred from the channel over which another symbol on the same antenna port is conveyed. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described above and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 2B, the base station 170 includes at least one processing unit 250, at least one transmitter 252, at least one receiver 254, two or more antennas 256, at least one memory 258, and one or more input/output devices or interfaces 266. More generally, there may be N antenna elements or antenna ports, where N>=1. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

Additional details regarding the EDs 110 and the base stations 170 are known to those of skill in the art. As such, these details are omitted here for clarity.

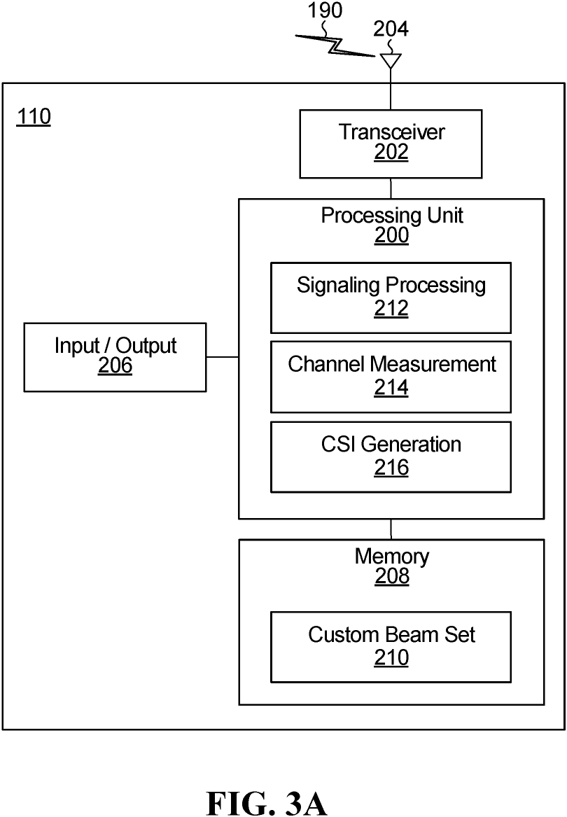

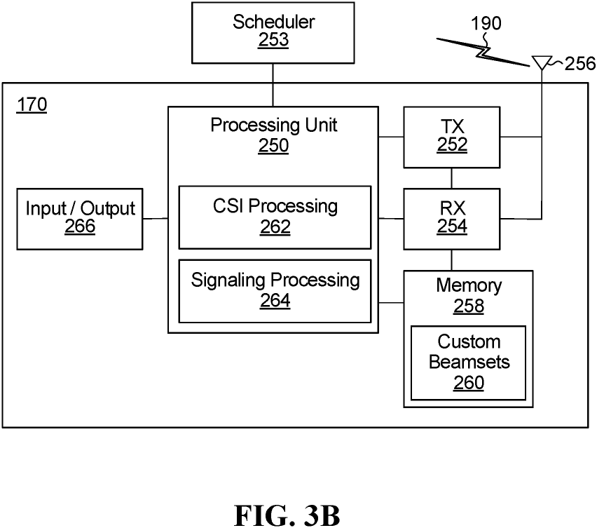

FIG. 3A shows a more detailed example of how the ED (more generally an apparatus) of FIG. 2A can be configured to implement embodiments of the disclosure. The ED of FIG. 3A includes a signaling processing module 212 for processing signaling from the network, a channel measurement module 214 for making channel measurements, and a CSI generation module 216 for processing the channel measurements to generate CSI to feedback to the network. The memory 210 contains a beam set configured via signaling from the network, that is used by the CSI generation module 216 to generate the CSI. Each beam in the beam set has a respective beam index. Details of the signaling used to configure the beam set, and the CSI generation are provided below.

FIG. 3B shows a more detailed example of how the base station (more generally a network device) of FIG. 2B can be configured to implement embodiments of the disclosure. The base station of FIG. 3B includes a signaling processing module 264 for generating signaling to send to a given ED, and a CSI processing module 262 for processing CSI received from the given ED. Also shown is a set one or more beam sets 260 stored in memory 258. The base station uses the signaling processing module 264 to generate signaling to send to the given ED to configure one of the beam sets 260 to be a beam set in the given ED. Different EDs may be configured with different beam sets depending in their environment. The CSI processing module 262 processes CSI feedback from a given ED based on the beam set configured for that ED and reconstructs downlink channel estimates. Details of how the beam sets are determined and signaled, and of CSI processing are provided below.

It should be understood that FIGS. 2A, 2B, 3A,3B are very specific implementations of base stations and EDs that may be used to implement embodiments of the disclosure, but that the disclosure is not limited to those specific implementations. In the following discussion, the device that receives of the reference signal, which in turn generates the CSI feedback using the beam set, is referred to a UE, but it should be understood that the receiver more generally can be any ED or apparatus can be configured to implement this functionality. Similarly, in the following discussion, the device that transmits the reference signal and receives the CSI feedback using the beam set, is referred to a base station, but it should be understood that more generally any network device can configured to implement this functionality.

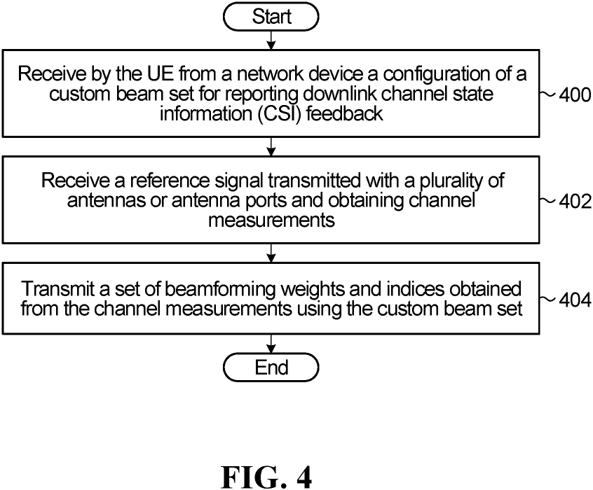

Referring now to FIG. 4, a flowchart of a method for execution by a UE, will now be described. Example detailed implementations of each of the blocks of FIG. 4 are provided below. The method begins in block 400 with receiving by the UE from a network device a respective configuration of each beam of a beam set for reporting downlink channel state information (CSI) feedback, each beam having a beam index. In some embodiments, the beam index is not included in the configuration, but rather the indices are assigned to the beams in the same order as the order that the beams are configured. In block 402, the UE receives a reference signal transmitted with a plurality of antennas or antenna ports and obtains channel measurements. In block 404, the UE transmits a set of beamforming weights and indices obtained from the channel measurements using the beam set. Typically, only a subset of the beams in the beam set is used to represent the channel or the precoding vectors, as described below. In such cases, to reduce CSI feedback, the UE only sends the weights for the beams in the subset. The UE also indicates the indices of the beams for which weights are being sent. In an embodiment in which all beamforming weights are always transmitted, it is not necessary for the UE to send the indices.

In some embodiments, the network device uses N antennas or antenna ports to transmit the reference signal, and the UE uses R antennas to receive the reference signal, where N>=2, and R>=1. In this case, a set of N channel measurements for each of the R antennas or antenna ports is obtained.

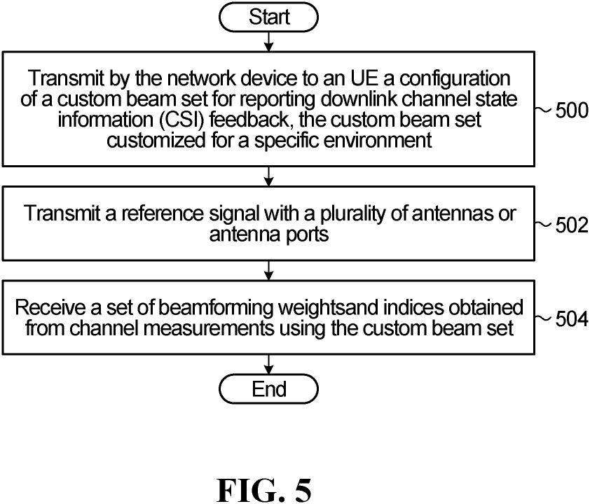

Referring now to FIG. 5, a flowchart of a method for execution by a base station will now be described. Example detailed implementations of each of the blocks of FIG. 5 are provided below. The method begins in block 500 with transmitting by the base station to a UE a respective configuration of each beam of a beam set for reporting downlink channel state information (CSI) feedback. The beam set may be customized for a specific environment. In block 502, the base station transmits a reference signal with a plurality of antennas or antenna ports. In block 504, the base station receives a set of beamforming weights and indices obtained from channel measurements using the beam set.

These approaches have the advantages of lower CSI feedback overhead given the same channel acquisition performance, better channel acquisition performance given the same CSI feedback overhead, and lower UE power consumption for selecting appropriate beams in the beam set.

### Beam Set Determination Using Autoencoder

In some embodiments, the beam set is by determined by training an autoencoder architecture using channel samples.

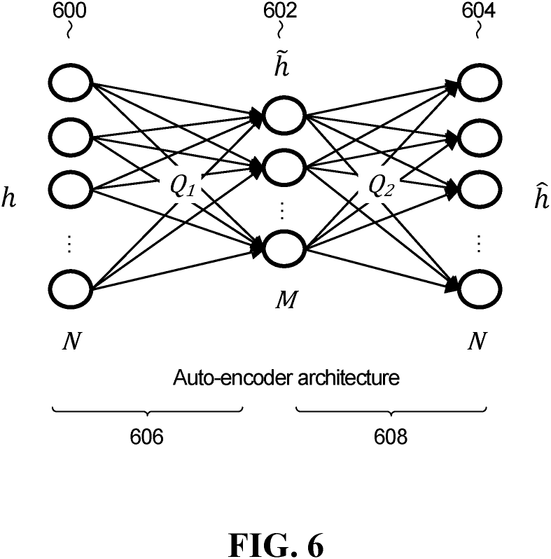

In this embodiment, downlink channel samples obtained from the environment are used to derive the beam set. An autoencoder architecture is employed that uses the downlink channel samples as input and outputs the beams (vectors) that represent a downlink channel subspace. FIG. 6 shows an autoencoder architecture with one input layer 600, one hidden layer 602 and one output layer 604. Also shown are an encoding layer 606, and a decoding layer 608. For the illustrated example, there is no nonlinear operation involved in the autoencoder operation (e.g., no nonlinear activation function). The size of the input and output layers 600, 602 is N, where N is the number of transmit antennas or transmit antenna ports. The size of the input and output layers equals the number of antennas N for the case an autoencoder implementation with complex numbers, where the channel samples are presented as complex numbers. For an autoencoder implementation with real numbers, the size of each of the layers doubles to represent both real and imaginary values.

The size of the hidden layer 602 is M. M is the size of the beam set being obtained. To achieve minimum beam set size, and maximum overhead savings, it is better for M to be as small as possible. However, for small values of M, the reconstruction of the downlink channel may incur high loss. So M may be chosen as a number, such as the smallest number, such that channel reconstruction loss is within acceptable values.

The input to the autoencoder architecture is a channel vector h that contains a channel sample for each of the N antennas. The encoding layer 606 of the autoencoder (represented by matrix Q₁) projects the channel vector h into column space of Q₁. The compressed version of the channel is h̅. The decoding layer 608 of the autoencoder (represented by matrix Q₂) reconstructs the channel vector h̅ from its compressed/reduced dimension version h̅. After training, each row of Q₂ is a beam. The beam set is given by taking all rows of Q₂.

The operation can be summarized as:

$${h}_{1 x N} \to {\tilde{h}}_{1 X M} \to {\hat{h}}_{1 X N} .$$

where the reduced dimension channel is given by

$$\hat{h} = h {Q}_{1}$$

where h̅ is the projection of h on the column space of Q₁, and the reconstructed channel is given by

$$\hat{h} = \tilde{h} {Q}_{2}$$

where h̅ is a linear combination of rows of Q₂.

If h̅ ≅ h, the row space of Q₂ gives the downlink channel subspace, meaning that the beam set is given by the rows of Q₂.

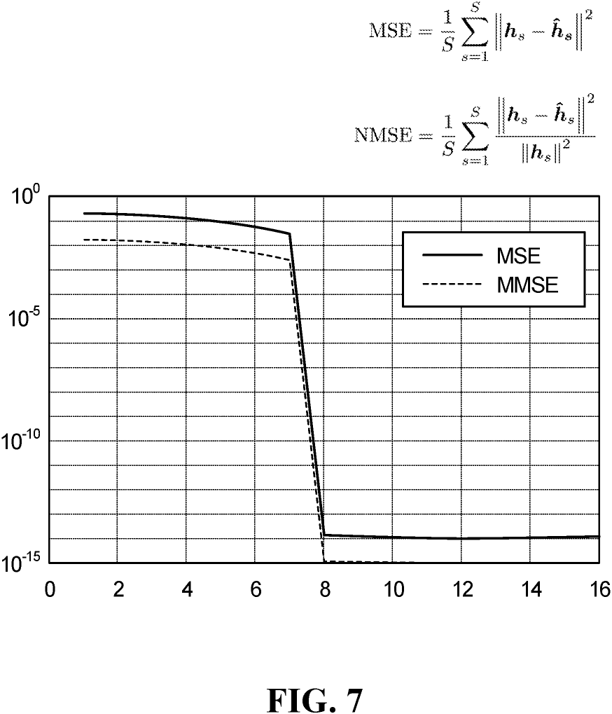

FIG. 7 shows an example of the effect of size M of the hidden layer. For this example, there are N =16 transmit antennas, and R= 1 receive antennas. For this example, channel samples (1×16 vectors) are generated using linear combinations of a size-8 subset of the rows of a 16-point DFT matrix (channel rank = 8). Results are shown for two different criteria for training the autoencoder, namely mean square error (MSE) and normalized MSE:

$$\text{MSE=} \frac{1}{s} {\sum }_{s = 1}^{s} {\left‖{h}_{s} - {\hat{h}}_{s}\right‖}^{2}$$

$$\text{NMSE=} \frac{1}{s} {\sum }_{s = 1}^{s} \frac{{\left‖{h}_{s} - {\hat{h}}_{s}\right‖}^{2}}{{\left‖{h}_{s}\right‖}^{2}}$$

The best channel reconstruction performance is achieved in both cases when M >= 8.

### Beam Set Determination Using Singular Value Decomposition

In some embodiments, the beam set is determined based on singular value decomposition (SVD) performed using channel samples. More specifically, the beam set comprises rows of a matrix V* corresponding to some or all non-zero singular values in Λ, where H = UΛV* is a singular value decomposition of an aggregate matrix containing stacked channel vector samples.

In this embodiment, the channel vector samples are stacked to form one single aggregate matrix H of size KxN where K is the number of channel sample vectors. The channel samples correspond to a MIMO channel with N transmit antennas and R receive antennas, and each row of the channel matrix sample serves as a separate channel vector sample. Then the SVD of the aggregate matrix H is taken according to:

$$H = U \text{Λ} V *$$

The rows of V* (singular vectors) corresponding to non-zero singular values in Λ are the beams that span the downlink channel subspace. In some embodiments, to further reduce the beam set size, the singular vectors corresponding to insignificant singular values are ignored. For example, in some embodiments, only beams that correspond to singular values that are above a threshold are used.

Other approaches to determining the beam set may alternatively be employed. For whatever approach is used, in some embodiments, multiple beam sets are determined for different environments, and a given UE is configured with the beam set appropriate for its environment.

### Channel Samples Used to Determine Beam Set

In some embodiments, the beam set is determined based on actual channel samples (data-driven approach). A given environment (for example: room, hallway, outdoor area, etc.) is represented by its channel samples, and the beam set is determined based on these channel samples. The process of determining the beam set may be offline or online. In some embodiments, multiple beam sets are determined offline for different environments.

In some embodiments, the channel samples used in determining the beam set (using one of the autoencoder or SVD approaches or some other approach) are downlink channel samples. In some embodiments, channel measurements are collected from UEs in a given environment through CSI feedback.

In some embodiments, the channel samples used in determining the beam set (using one of the autoencoder or SVD approaches or some other approach) are uplink channel samples. For example, the network may collect channel samples from uplink sounding reference signal (SRS) transmitted by UEs in given environment. This embodiment is based on uplink and downlink channel subspace reciprocity.

In some embodiments, channel samples used to determine the beam set are determined using a sensing-based approach. In some embodiments, the channel samples used in determining the beam set (using one of the autoencoder or SVD approaches or some other approach) are samples generated according to a transmitter antenna array steering vector at angles of departure/arrival within an angle of departure/arrival range. In this case, the channel samples are artificially generated, using a formula, from the angle of departure/angle of arrival obtained through sensing.

### Signalling of the Beam Set

Having determined one or more beam sets, as described above, a specific beam set is configured on a UE through signalling transmitted by a base station to the UE. In some embodiments, radio resource control (RRC) signalling is transmitted by the base station, and received by the UE, and the RRC signalling contains a configuration of the beam set. In a specific example, the configuration of the beam set is in the form of a matrix whose rows or columns are the beams of the beam set. In another example, the configuration of the beam set is in the form of a set of vectors, each representing one beam of the beam set. Other signalling approaches may be used.

Where the beam set for a given UE was generated based on channel samples from that UE, that beam set is configured for that UE specifically, and in that sense, the beam set is UE-specific.

In some embodiments, multiple beam sets are determined for different environmental conditions. These can be determined based on channel samples collected for the different environmental conditions. The network configures the UE with the appropriate beam set based on the environmental conditions of the UE. The network may determine the environment of the UE based on the UE location.

### Channel Measurement

As described above, in some embodiments, the base station uses N antennas or antenna ports to transmit the reference signal, and the UE uses R antennas to receive the reference signal, where N>=2, and R>=1. In this case, a set of N channel measurements for each of the R antennas or antenna ports is obtained.

### CSI Generation and Feedback

In the UE, a set of channel estimates (or multiple sets which may be for respective receive antennas or respective spatial layers) are obtained, and for each set, beamforming weights are determined for the beam set. A spatial layer in a MIMO context is the number of independent data streams that can be reliably transmitted over a MIMO channel. Roughly speaking, the larger the number of antennas at the base station and the UE, the larger the number of layers that can be supported.

In some embodiments, the R sets of N channel measurements (equivalently a measured channel matrix of dimension RxN) for the R receive antennas are used to determine L precoding (beamforming) vectors of size N, where L≤R, where L is a number of spatial layers. L is also upper bounded by the number of antenna ports, in situations where antenna ports are used. In other words, L≤min(R,N). L can be determined by the UE, or alternatively, L can be configured through RRC signalling. There are two main options for CSI feedback that may be employed. A first option involves using CSI feedback to enable channel reconstruction at base station. In this case, the UE sends the R channel vectors (each corresponding to a receive antenna) represented as a linear combination of the beams in the beam set. In other words, for each channel vector, the indices of the beams that are used for representing the channel vector, along with the corresponding beam weights, are sent to the BS.

A second option involves using CSI feedback to convey precoding vectors: In this case, the UE sends a precoding vector, corresponding to each layer, as represented as a linear combination of the beams in the beam set. In other words, for each layer, the indices of the beams that are used to represent the precoding vector, along with the corresponding beamforming weights, are sent to the BS.

For example, in a specific implementation, there may be N=16 transmit antennas and R=4 receive antennas, but only L=2 layers. Based on the measured channel matrix (of dimension 4×16) at a UE, the UE finds 2 precoding (beamforming) vectors of size 16. Each of 2 precoding vectors is then represented as a linear combination of beams in the beam set and the corresponding weights are sent to the BS.

In a specific example, the precoding vectors are determined by calculating an SVD of a measured channel matrix H = UΛV*, and using L singular vectors of V as the L precoding vectors.

The precoding vectors are then used as a basis for determining the beamforming weights and indices using the beam set. In an example method, this involves determining beamforming weights and indices that represent the L precoding vector as a weighted linear combination of beams in the beam set.

After the beamforming weights are determined, CSI is transmitted through an uplink channel that includes, for example, the indices of beams in the beam set and their corresponding weights in the linear combination for each of L precoding vectors.

### CSI Feedback Processing

As noted above, there are two main options for CSI feedback that may be employed. The first option involves using CSI feedback to enable channel reconstruction at the base station. In this case, the base station can reconstruct the channel matrix from CSI feedback using the beam set configured to that UE. Channel reconstruction can involve, for example, using the beamforming weights and the corresponding beams in the beam set to reconstruct the channel measurements by determining a sum of the beamforming weights multiplied by beams of the beam set.

The second option involves using CSI feedback to convey precoding vectors. In this case, the base station can use the precoding vector for each layer for subsequent data transmission.

In some embodiments, as described above, the transmitted CSI feedback is received for each of a set of R receive antennas in the UE, or for each of a set of L layers. In this case, the base station reconstructs a respective set of channel measurements for each of the R receive antennas or for each of the L layers.

Numerous modifications and variations of the present disclosure are possible in light of the above teachings. It is therefore to be understood that within the scope of the appended claims, the disclosure may be practiced otherwise than as specifically described herein.

1. A method comprising:
receiving a respective configuration of each beam of a beam set for reporting downlink channel state information (CSI) feedback, each beam having a beam index;
receiving a reference signal transmitted with a plurality of antennas or antenna ports and obtaining channel measurements; and
transmitting a set of beamforming weights and corresponding beam indices obtained from the channel measurements using the beam set.

2. The method of claim 1 wherein:
receiving the reference signal transmitted with a plurality of antennas or antenna ports comprises receiving the reference signal transmitted with N antennas or antenna ports, where N≥2;
receiving the reference signal is performed with a plurality R of antennas or antenna ports, where R≥1; and
obtaining channel measurements comprises obtaining a set of N channel measurements for each of the R antennas or antenna ports.

3. The method of claim 2 further comprising:
determining L precoding vectors of size N from the R sets of N channel measurements where L≤min(R,N) is a number of spatial layers;
wherein transmitting the set of beamforming weights and corresponding beam indices obtained from the channel measurements using the beam set comprises:
for each of the L layers, transmitting a respective layer specific set of beam indices and the corresponding layer specific beamforming weights obtained from the precoding vector for that layer using the beam set.

4. The method of claim 1 further comprising obtaining the beamforming weights and indices from the channel measurements using the beam set by determining beamforming weights by:
calculating a singular value decomposition SVD of a measured channel matrix H = UΛV*;
determining L precoding vectors by using L singular vectors of V as the L precoding vectors, where L is a number of spatial layers; and
for each of the L precoding vectors, determining beamforming weights that represent the L precoding vector as a weighted linear combination of beams in the beam set.

5. The method of claim 1 further comprising obtaining the beamforming weights and indices from the channel measurements using the beam set by determining indices of beams within the beam set and corresponding weights of beams in the beam set for representing the channel vector as a weighted linear combination of the beams within the beam set.

6. A method comprising:
transmitting a respective configuration of each beam of a beam set for reporting downlink channel state information (CSI) feedback, each beam having a beam index;
transmitting a reference signal with a plurality of antennas or antenna ports; and
receiving a set of beamforming weights and corresponding beam indices obtained from channel measurements using the beam set.

7. The method of claim 6 further comprising:
using the beamforming weights and beam indices and the beam set to reconstruct at least one of: the channel measurements or a respective precoding vector for each of L layers.

8. The method of claim 7 wherein:
using the beamforming weights and beam indices and the beam set to reconstruct the channel measurements comprises determining a sum of the beamforming weights multiplied by beams of the beam set.

9. The method of claim 6 wherein the beam set comprises rows of a matrix V* corresponding to some or all non-zero singular values in Λ, where H = UAV* is a singular value decomposition of an aggregate matrix containing stacked channel vector samples.

10. The method of claim 6 wherein:
receiving a set of beamforming weights and indices obtained from the channel measurements using the beam set comprises, for each of L layers, receiving a respective set of beamforming weights and indices obtained from a set of channel measurements for that layer using the beam set.

11. An apparatus comprising a processor and a memory, the processor configured to cause the apparatus to perform a method comprising:
receiving a respective configuration of each beam of a beam set for reporting downlink channel state information (CSI) feedback, each beam having a beam index;
receiving a reference signal transmitted with a plurality of antennas or antenna ports and obtaining channel measurements; and
transmitting a set of beamforming weights and corresponding beam indices obtained from the channel measurements using the beam set.

12. The apparatus of claim 11 wherein:
receiving the reference signal transmitted with a plurality of antennas or antenna ports comprises receiving the reference signal transmitted with N antennas or antenna ports, where N≥2;
receiving the reference signal is performed with a plurality R of antennas or antenna ports, where R≥1; and
obtaining channel measurements comprises obtaining a set of N channel measurements for each of the R antennas or antenna ports.

13. The apparatus of claim 12 wherein the method performed by the apparatus further comprises:
determining L precoding vectors of size N from the R sets of N channel measurements where L≤min(R,N) is a number of spatial layers;
wherein transmitting the set of beamforming weights and corresponding beam indices obtained from the channel measurements using the beam set comprises:
for each of the L layers, transmitting a respective layer specific set of beam indices and the corresponding layer specific beamforming weights obtained from the precoding vector for that layer using the beam set.

14. The apparatus of claim 11 wherein the method performed by the apparatus further comprises obtaining the beamforming weights and indices from the channel measurements using the beam set by determining beamforming weights by:
calculating a singular value decomposition SVD of a measured channel matrix H = UAV*;
determining L precoding vectors by using L singular vectors of V as the L precoding vectors, where L is a number of spatial layers; and
for each of the L precoding vectors, determining beamforming weights that represent the L precoding vector as a weighted linear combination of beams in the beam set.

15. The apparatus of claim 11 wherein the method performed by the apparatus further comprises obtaining the beamforming weights and indices from the channel measurements using the beam set by determining indices of beams within the beam set and corresponding weights of beams in the beam set for representing the channel vector as a weighted linear combination of the beams within the beam set.

16. An apparatus comprising a processor and a memory, the processor configured to cause the apparatus to perform a method comprising:
transmitting a respective configuration of each beam of a beam set for reporting downlink channel state information (CSI) feedback, each beam having a beam index;
transmitting a reference signal with a plurality of antennas or antenna ports; and
receiving a set of beamforming weights and corresponding beam indices obtained from channel measurements using the beam set.

17. The apparatus of claim 16 wherein the method performed by the apparatus further comprises:
using the beamforming weights and beam indices and the beam set to reconstruct at least one of: the channel measurements or a respective precoding vector for each of L layers.

18. The apparatus of claim 17 wherein:
using the beamforming weights and beam indices and the beam set to reconstruct the channel measurements comprises determining a sum of the beamforming weights multiplied by beams of the beam set.

19. The apparatus of claim 16 wherein the beam set comprises rows of a matrix V* corresponding to some or all non-zero singular values in Λ, where H = UAV* is a singular value decomposition of an aggregate matrix containing stacked channel vector samples.

20. The apparatus of claim 16 wherein:
receiving a set of beamforming weights and indices obtained from the channel measurements using the beam set comprises, for each of L layers, receiving a respective set of beamforming weights and indices obtained from a set of channel measurements for that layer using the beam set.
